(19) United States
(12) Patent Application Publication
(10) Pub. No.: US 2026/0023548 A1
(43) Pub. Date: Jan. 22, 2026

(54) METHODS AND SYSTEMS FOR FACILITATING DECOMMISSIONING OF A SOFTWARE APPLICATION

(71) Applicants: Joseph Labbe, Manhasset, NY (US); George Patrick Weihs, Doylestown, PA (US); Jason Burns, Cinnaminson, NJ (US)

(72) Inventors: Joseph Labbe, Manhasset, NY (US); George Patrick Weihs, Doylestown, PA (US); Jason Burns, Cinnaminson, NJ (US)

(21) Appl. No.: 19/089,912

(22) Filed: Mar. 25, 2025

Related U.S. Application Data
(60) Provisional application No. 63/672,090, filed on Jul. 16, 2024.

(51) Int. Cl. G06F 8/61; G06F 21/31

(52) U.S. Cl. CPC G06F 8/62; G06F 21/31

(57) ABSTRACT

The present disclosure provides a method for facilitating decommissioning of a software application. Further, the method may include receiving, using a communication device, an entity data from a user device. Further, the method may include generating an instruction data based on the entity data. Further, the instruction data represents a set of human-equivalent automated actions performed by a software bot. Further, the method may include executing the instruction data. Further, the executing may be based on a bot configured to mimic a structured user interaction with the software application. Further, the method may include extracting a record data based on the executing. Further, the method may include generating a structured document data based on the extracting. Further, the method may include transmitting, using the communication device, the structured document data to the user device.

### REFERENCE TO RELATED APPLICATIONS

This application claims the benefit of U.S. Provisional Patent Application No. 63/672,090 filed on Jul. 16, 2024, which is incorporated by reference herein in its entirety.

### FIELD OF DISCLOSURE

The present disclosure generally relates to a field of data processing. More specifically, the present disclosure relates to methods and systems for facilitating decommissioning of a software application.

### BACKGROUND

Currently, organizations are adopting cloud-based systems to fulfill contemporary expectations. But, it leads to an unintended consequence like a rapid proliferation of legacy systems which escalates technical debt, an accumulation of maintenance costs, and inefficiencies that the new cloud-based systems were supposed to mitigate. Existing data preserving systems are limited in preserving a contextual data that organizations rely on. Further, they failed to meet the needs of the organizations.

Therefore, there is a need for improved methods and systems for facilitating decommissioning of a software application, that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method for facilitating decommissioning of a software application. Further, the method may include receiving, using a communication device, an entity data from a user device. Further, the entity data may represent a record associated with the software application. Further, the method may include receiving, using the communication device, a login credential data from the user device. Further, the login credential data corresponds to a unique identifier of a user associated with the software application. Further, the method may include generating, using a processing device, an instruction data based on each of the entity data and the login credential data. Further, the instruction data represents a set of human-equivalent automated actions performed by a software bot. Further, the set of human-equivalent automated actions may include one or more of an interacting with a Graphical User Interface of the software application, executing an Application Programming Interface calls to retrieve data and performing a direct database query. Further, the method may include executing, using the processing device, the instruction data. Further, the executing may be based on a bot configured to mimic a structured user interaction with the software application. Further, the method may include extracting, using the processing device, a record data based on the executing. Further, the record data may include one or more of a screenshot of a record display, a structured field data from a database of the software application and a documents attached to the record and an output from an executed report associated with or that which reference data contained within the record. Further, the method may include generating, using the processing device, a structured document data based on the extracting. Further, the structured document data corresponds to a document comprising the record data in a structured format. Further, the method may include transmitting, using the communication device, the structured document data to the user device.

The present disclosure provides a system for facilitating decommissioning of a software application. Further, the system may include a communication device. Further, the communication device may be configured for receiving an entity data from a user device. Further, the entity data may represent a record associated with the software application. Further, the communication device may be configured for receiving a login credential data from the user device. Further, the login credential data corresponds to a unique identifier of a user associated with the software application. Further, the communication device may be configured for transmitting a structured document data to the user device. Further, the system may include a processing device. Further, the processing device may be configured for generating an instruction data based on each of the entity data and the login credential data. Further, the instruction data represents a set of human-equivalent automated actions performed by a software bot. Further, the set of human-equivalent automated actions may include one or more of an interacting with a Graphical User Interface of the software application, executing an Application Programming Interface calls to retrieve data and performing a direct database query. Further, the processing device may be configured for executing the instruction data. Further, the executing may be based on a bot configured to mimic a structured user interaction with the software application. Further, the processing device may be configured for extracting a record data based on the executing. Further, the record data may include one or more of a screenshot of a record display, a structured field data from a database of the software application and a documents attached to the record and an output from an executed report associated with or that which reference data contained within the record. Further, the processing device may be configured for generating the structured document data based on the extracting. Further, the structured document data corresponds to a document comprising the record data in a structured format.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 for facilitating decommissioning of a software application, in accordance with some embodiments.

FIG. 3B illustrates a continuation of the flowchart of the method 300 for facilitating decommissioning of a software application, in accordance with some embodiments.

FIG. 4 illustrates a flowchart of a method 400 for facilitating decommissioning of a software application including generating, using the processing device 804, an execution error data, in accordance with some embodiments.

FIG. 5 illustrates a flowchart of a method 500 for facilitating decommissioning of a software application including executing, using the processing device 804, the execution response data, in accordance with some embodiments.

FIG. 6 illustrates a flowchart of a method 600 for facilitating decommissioning of a software application including generating, using the processing device 804, an anomaly identification data, in accordance with some embodiments.

FIG. 7 illustrates a flowchart of a method 700 for facilitating decommissioning of a software application including identifying, using the processing device 804, the anomaly data, in accordance with some embodiments.

FIG. 8 illustrates a block diagram of a system 800 for facilitating decommissioning of a software application, in accordance with some embodiments.

FIG. 9 illustrates a flowchart of a method 900 for facilitating decommissioning of a software application including executing, using the processing device 804, the anomaly response data, in accordance with some embodiments.

FIG. 10 is a flow chart of a method 1000 for facilitating providing information associated with a software application, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The digital age, characterized by relentless evolution, promises a plethora of advantages for businesses through system modernization and digitalization. These advantages include better customer and employee interactions, data-driven decision-making, and streamlined operations. However, the rush to modern has left a mess in its wake. As organizations enthusiastically adopt cloud-based systems to fulfill contemporary expectations, an unintended consequence has emerged: the rapid proliferation of legacy systems. Instead of phasing out the old, organizations are inadvertently adding to their portfolio of dated, inflexible applications. The irony is stark; in the pursuit of modernity, entities inadvertently cultivate a growing burden of obsolescence.

While new systems are swiftly integrated, the retirement strategies for old systems lag, creating an alarming mismatch. Organizations find themselves burdened with escalating technical debt, an accumulation of maintenance costs, and inefficiencies that the new systems were supposed to mitigate. According to Gartner, the number of legacy systems slated for decommissioning in the years 2016 through 2019 outpaced the number of systems decommissioned during years 2000 to 2015 by 300%. The problem is growing. But the fallout isn't merely technical. On the human front, employees, the heartbeat of any organization, find themselves navigating turbulent waters. Insufficient change management practices leave them uncertain, even anxious, about their evolving roles and the tools they must use. In addition, customer experiences are fragmented and inconsistent.

Further complicating the landscape is the sprawling “wilderness” of decommissioning. This vast, often poorly navigated territory has become a magnet for compliance violations and risk exposures. The challenge is clear: while businesses chase the future, they're haunted by the specters of the past. Traditional methods of data preservation, though available, fall short of today's demands. Not only are they financially and operationally draining, but they also strip data of its rich context. Without this context, data loses its narrative, making it arduous to access, comprehend, and leverage. Organizations are susceptible to costly compliance pitfalls and miss out on potential insights hidden within their own history. The dream of a seamless digital evolution is currently mired in complexities. Organizations must urgently rethink their approach to system decommissioning, ensuring that while they stride forward into the future, they don't neglect the lessons and legacies of the past.

The present disclosure relates to a “Legacy Snapshot”. However, in the process, they also solved the broader problem of how organizations can create purpose driven extracts of application information and house them in collections of AI-ready PDF documents called “snapshots”. This solution maximizes fidelity from both an aesthetic and informational perspective, whether for decommissioning a legacy system, integrating information from a software application inherited through a merger, acquisition, or carve-out, or accommodating an on-demand information request. The methods and systems disclosed herein can be called as RoDA (Robotic Document Assembly)

RoDA is a software-backed method for extracting information from a software application to create an AI-ready, PDF-formatted archive. By creating such an archive, organizations can make application information easily accessible and understandable to others without requiring others having access to the actual software application or underlying database.

The methods and systems utilize software robots (called “snapbots”) and AI to extract specific types of information for each record in an application the user wants to preserve. The process of extracting is illustrated in FIG. 11. The process begins with the creation of a schema that defines the shape of the information that should be extracted from the application. Each section of the schema is called a “field”. The system also allows for the creation of one or more layouts that govern the format and number of documents that are contained in the snapshot.

After the schema is created, “snapbots” are encoded with instructions regarding how to do the following to gather the field instance information from each application record:
Load the application.
Log in to the application.
Search for a specific record in the application.
Navigate to each section of the record (including setting the application's state).
Extract screenshots.
Extract application metadata.
Download attached documents.
Locate, execute and capture report information.
Close the application.

After the schema is created and the snapbots configured, a list of “entities” must be imported into the invention so the snapbots know which records in the application should be extracted. This list must contain enough unique identifiable information for each entity so the corresponding record in the application can be searched for and found.

After the list is imported, the invention creates and queues a series of jobs that will be accessed by the snapbots to gather the information from the application. The number of jobs usually corresponds on a one-to-one basis with the number items in the list.

Once the jobs queue is created, one or more snapbots call the queue via our snapbot gateway and claim a job for processing. Each snapbot extracts the fields from the application per the entity defined in the job. If the snapbot collects the fields successfully based on its configuration, the extracted fields instance data is stored in the invention's database and the job is flagged for downstream anomaly detection. If the snapbot does not process the job successfully per its configuration, the job is flagged for manual review.

Any job that is successfully processed by a snapbot per its configuration, is then processed by an anomaly detection service that scans the fields for consistency. If no anomalies are detected, the job is flagged as completed. If anomalies are detected, the job is flagged for manual review.

At any point while jobs are being processed, a user can review the job queue for jobs that are flagged for manual review. After reviewing any issues with a flagged job, the user can manually re-flag the job as “ready for processing” so it is re-queued for a snapbot to process.

After all the jobs are processed successfully, the invention assembles the gathered fields for a given snapshot and creates both a PDF (snapshot document) that contains all the fields and a secondary file that contains just extracted field data. The format of the fields corresponds to the layout. There may be more than one PDF and secondary field data file depending upon the number of layouts defined. The entirety of all the PDF files and all the secondary field data fields constitutes the full snapshot.

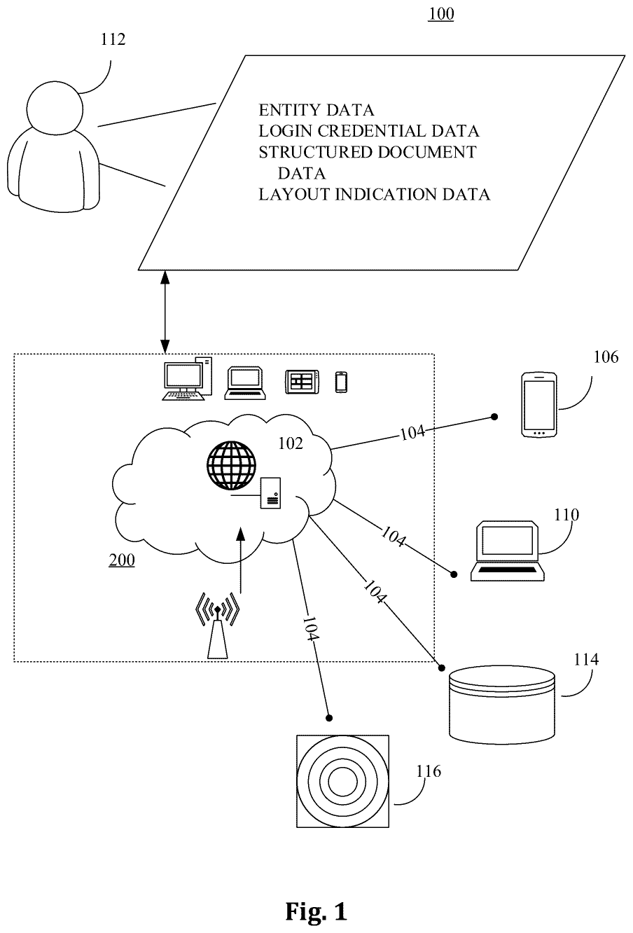

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

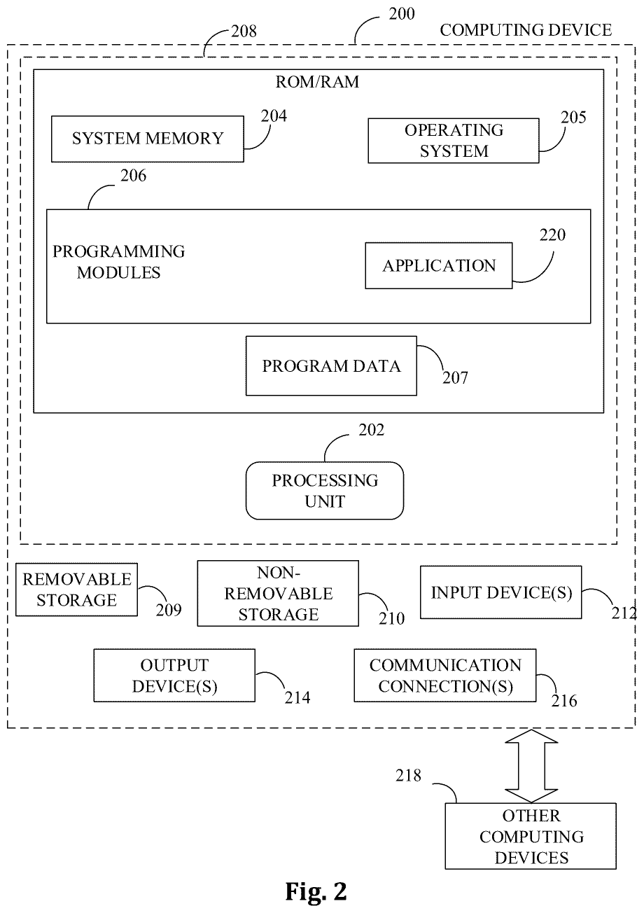

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200′s operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types.

Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

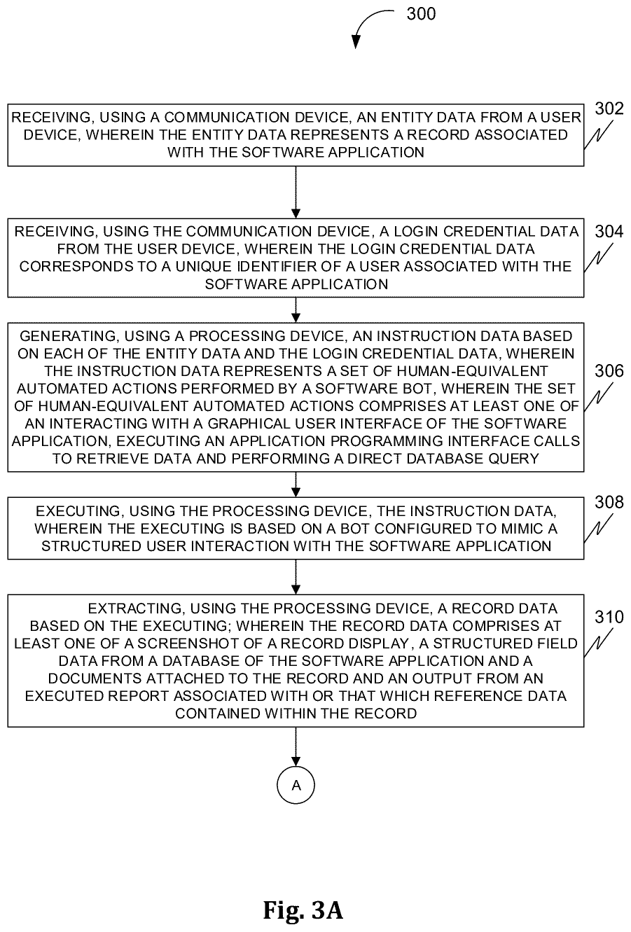

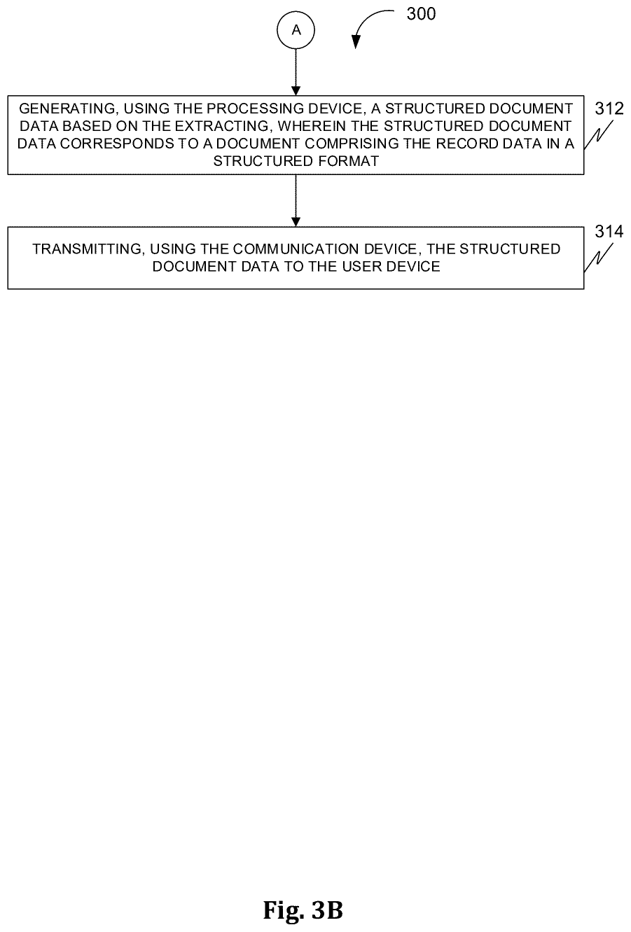

FIG. 3A and FIG. 3B illustrate a flowchart of a method 300 for facilitating decommissioning of a software application, in accordance with some embodiments.

Accordingly, the method 300 may include a step 302 of receiving, using a communication device 802, an entity data from a user device. Further, the entity data may represent a record associated with the software application. Further, the method 300 may include a step 304 of receiving, using the communication device 802, a login credential data from the user device. Further, the login credential data corresponds to a unique identifier of a user associated with the software application. Further, the method 300 may include a step 306 of generating, using a processing device 804, an instruction data based on each of the entity data and the login credential data. Further, the instruction data represents a set of human-equivalent automated actions performed by a software bot. Further, the set of human-equivalent automated actions may include one or more of an interacting with a Graphical User Interface of the software application, executing an Application Programming Interface calls to retrieve data and performing a direct database query. Further, the method 300 may include a step 308 of executing, using the processing device 804, the instruction data. Further, the executing may be based on a bot configured to mimic a structured user interaction with the software application. Further, the method 300 may include a step 310 of extracting, using the processing device 804, a record data based on the executing. Further, the record data may include one or more of a screenshot of a record display, a structured field data from a database of the software application and a documents attached to the record and an output from an executed report associated with or that which reference data contained within the record. Further, the method 300 may include a step 312 of generating, using the processing device 804, a structured document data based on the extracting. Further, the structured document data corresponds to a document comprising the record data in a structured format. Further, the method 300 may include a step 314 of transmitting, using the communication device 802, the structured document data to the user device.

In some embodiments, the method 300 may further include generating, using the processing device 804, a schema data based on the entity data. Further, the schema data corresponds to two or more sections associated with the record. Further, the generating of the instruction data may be further based on the schema data.

In some embodiments, the method 300 may further include generating, using the processing device 804, the layout data based on the entity data. Further, the layout data corresponds to an arrangement of two or more record data in the structured format. Further, the generating of the structured document data may be further based on the layout data.

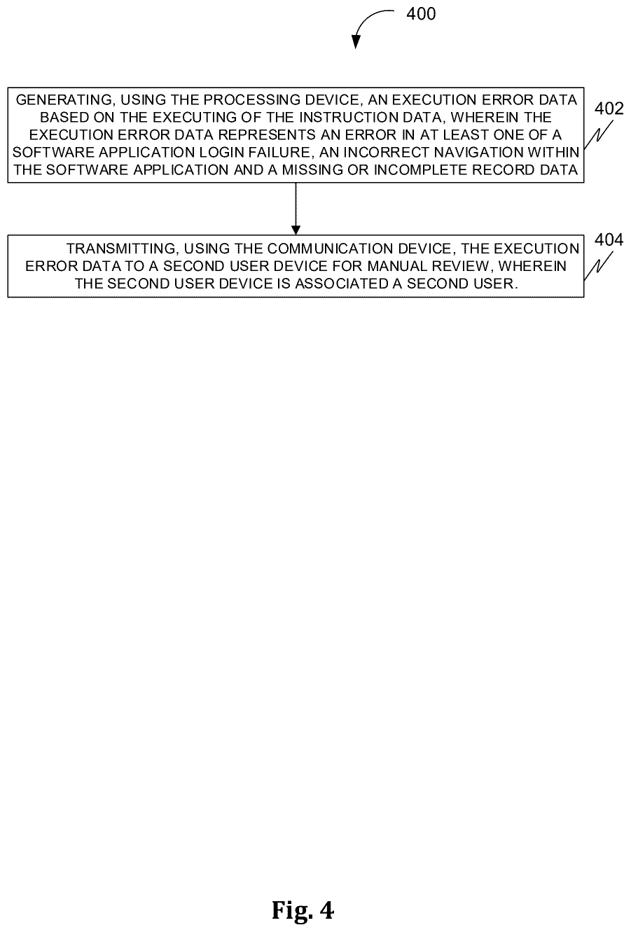

FIG. 4 illustrates a flowchart of a method 400 for facilitating decommissioning of a software application including generating, using the processing device 804, an execution error data, in accordance with some embodiments.

Further, in some embodiments, the method 400 further may include a step 402 of generating, using the processing device 804, an execution error data based on the executing of the instruction data. Further, the execution error data represents an error in one or more of a software application login failure, an incorrect navigation within the software application and a missing or incomplete record data. Further, in some embodiments, the method 400 may include a step 404 of transmitting, using the communication device 802, the execution error data to a second user device for manual review. Further, the second user device may be associated with a second user.

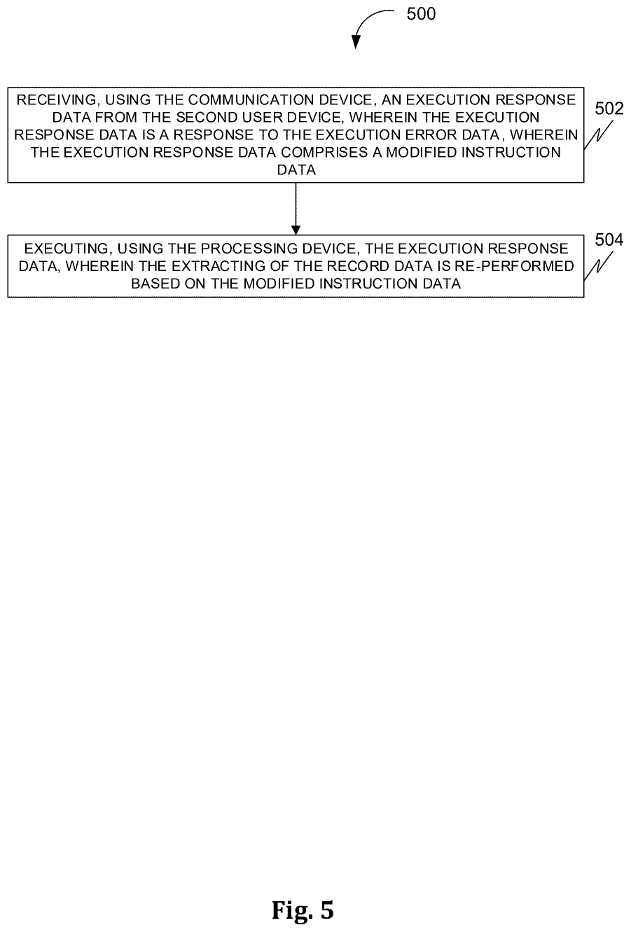

FIG. 5 illustrates a flowchart of a method 500 for facilitating decommissioning of a software application including executing, using the processing device 804, the execution response data, in accordance with some embodiments.

Further, in some embodiments, the method 500 further may include a step 502 of receiving, using the communication device 802, an execution response data from the second user device. Further, the execution response data may be a response to the execution error data. Further, the execution response data includes a modified instruction data. Further, in some embodiments, the method 500 further may include a step 504 of executing, using the processing device 804, the execution response data. Further, the extracting of the record data is re-performed based on the modified instruction data.

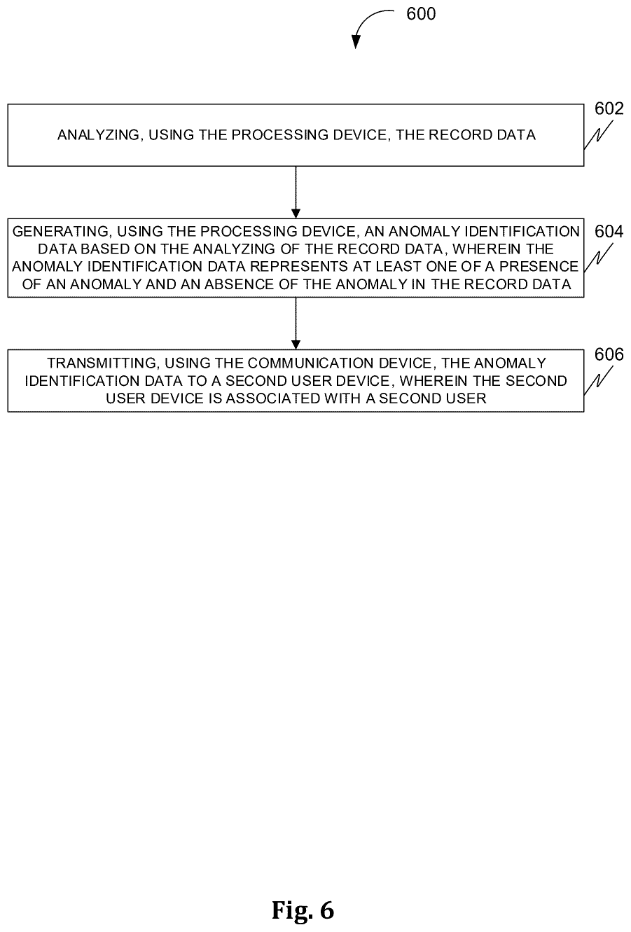

FIG. 6 illustrates a flowchart of a method 600 for facilitating decommissioning of a software application including generating, using the processing device 804, an anomaly identification data, in accordance with some embodiments.

Further, in some embodiments, the method 600 further may include a step 602 of analyzing, using the processing device 804, the record data. Further, in some embodiments, the method 600 may include a step 604 of generating, using the processing device 804, an anomaly identification data based on the analyzing of the record data. Further, the anomaly identification data represents one or more of a presence of an anomaly and an absence of the anomaly in the record data. Further, in some embodiments, the method 600 further may include a step 606 of transmitting, using the communication device 802, the anomaly identification data to a second user device. Further, the second user device may be associated with a second user.

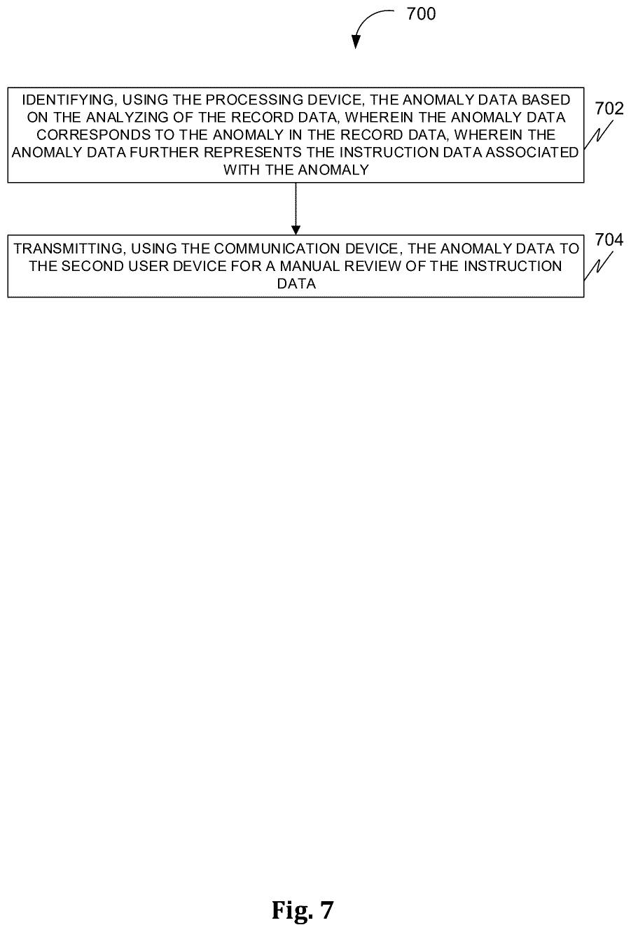

FIG. 7 illustrates a flowchart of a method 700 for facilitating decommissioning of a software application including identifying, using the processing device 804, the anomaly data, in accordance with some embodiments.

Further, in some embodiments, the method 700 may include a step 702 of identifying, using the processing device 804, the anomaly data based on the analyzing of the record data. Further, the anomaly data corresponds to the anomaly in the record data. Further, the anomaly data represents the instruction data associated with the anomaly. Further, in some embodiments, the method 700 may include a step 704 of transmitting, using the communication device 802, the anomaly data to the second user device for a manual review of the instruction data.

In some embodiments, the method 300 may further include storing, using a storage device, the structured document data in a database for a future reference. Further, the database includes two or more structured document data stored at two or more time instances.

In some embodiments, the structured document data includes two or more documents. Further, the two or more documents includes a first document and a second document. Further, the first document includes one or more of two or more images and a downloaded document. Further, the second document includes two or more field data associated with one or more of the two or more images and the downloaded document.

In some embodiments, the extracting of the record data may be further based on an AI model. Further, the AI model may be trained on one or more of a metadata from previously extracted record, an application-specific navigation pattern, a prior error log and manual correction and a predictive data structure inferred from previous extraction

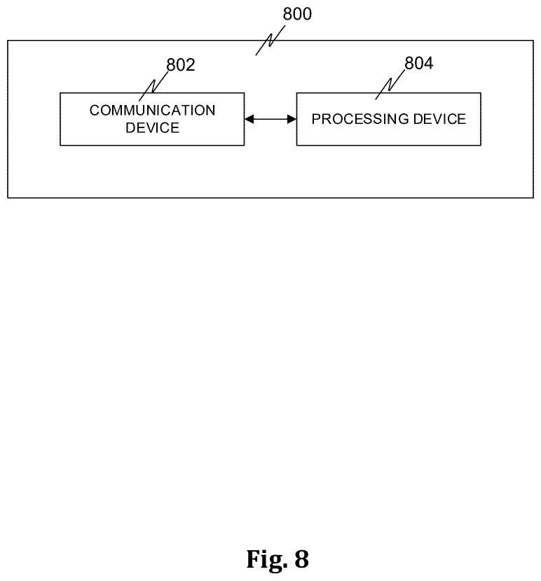

FIG. 8 illustrates a block diagram of a system 800 for facilitating decommissioning of a software application, in accordance with some embodiments.

Accordingly, the system 800 may include a communication device 802. Further, the communication device 802 may be configured for receiving an entity data from a user device. Further, the entity data may represent a record associated with the software application. Further, the communication device 802 may be configured for receiving a login credential data from the user device. Further, the login credential data corresponds to a unique identifier of a user associated with the software application. Further, the communication device 802 may be configured for transmitting a structured document data to the user device. Further, the system 800 may include a processing device 804. Further, the processing device 804 may be configured for generating an instruction data based on each of the entity data and the login credential data. Further, the instruction data represents a set of human-equivalent automated actions performed by a software bot. Further, the set of human-equivalent automated actions may include one or more of an interacting with a Graphical User Interface of the software application, executing an Application Programming Interface calls to retrieve data and performing a direct database query. Further, the processing device 804 may be configured for executing the instruction data. Further, the executing may be based on a bot configured to mimic a structured user interaction with the software application. Further, the processing device 804 may be configured for extracting a record data based on the executing. Further, the record data may include one or more of a screenshot of a record display, a structured field data from a database of the software application and a documents attached to the record and an output from an executed report associated with or that which reference data contained within the record. Further, the processing device 804 may be configured for generating the structured document data based on the extracting. Further, the structured document data corresponds to a document comprising the record data in a structured format.

In some embodiments, the processing device 804 may be further configured for generating a schema data based on the entity data. Further, the schema data corresponds to two or more sections associated with the record. Further, the generating of the instruction data may be further based on the schema data.

In some embodiments, the processing device 804 may be further configured for generating the layout data based on the entity data. Further, the layout data corresponds to an arrangement of two or more record data in the structured format. Further, the generating of the structured document data may be further based on the layout data. Further, the record data includes two or more record data.

In some embodiments, the processing device 804 may be further configured for generating an execution error data based on the executing of the instruction data. Further, the execution error data represents an error in one or more of a software application login failure, an incorrect navigation within the software application and a missing or incomplete record data. Further, the communication device 802 may be further configured for transmitting the execution error data to a second user device for manual review. Further, the second user device may be associated a second user.

In some embodiments, the communication device 802 may be further configured for receiving an execution response data from the second user device. Further, the execution response data may be a response to the execution error data. Further, the execution response data includes a modified instruction data. Further, the processing device 804 may be further configured for executing the execution response data. Further, the extracting of the record data is re-performed based on the modified instruction data.

Further, in some embodiments, the processing device 804 may be configured for analyzing the record data. Further, the processing device 804 may be configured for generating an anomaly identification data based on the analyzing of the record data. Further, the anomaly identification data represents one or more of a presence of an anomaly and an absence of the anomaly in the record data. Further, the communication device 802 may be configured for transmitting the anomaly identification data to a second user device. Further, the second user device may be associated with a second user.

In some embodiments, the processing device 804 may be further configured for identifying the anomaly data based on the analyzing of the record data. Further, the anomaly data corresponds to the anomaly in the record data. Further, the anomaly data further represents the instruction data associated with the anomaly. Further, the communication device 802 may be further configured for transmitting the anomaly data to the second user device for a manual review of the instruction data.

In some embodiments, the system 800 may further include a storage device which may be configured for storing the structured document data in a database for a future reference. Further, the database includes two or more structured document data stored at two or more time instances.

In some embodiments, the structured document data includes two or more documents. Further, the two or more documents includes a first document and a second document. Further, the first document includes one or more of two or more images and a downloaded document. Further, the second document includes two or more field data associated with one or more of the two or more images and the downloaded document.

In some embodiments, the extracting of the record data may be further based on an AI model. Further, the AI model is trained on one or more of a metadata from previously extracted record, an application-specific navigation pattern, a prior error log and manual correction and a predictive data structure inferred from previous extraction.

In some embodiments, the executing includes initializing the software application. Further, initializing includes one or more of a loading the software application and a logging in the software application. Further, the logging in the software application may be based on the login credential data.

In some embodiments, the executing further includes interacting with a Graphical User Interface of the software application.

In some embodiments, the interacting resembles two or more human interactions between the user and one or more of a user input device and a user presentation device. Further, the user device may be associated with each of the user input device and the user presentation device. Further, the user device may be associated with the user.

In some embodiments, the set of human actions corresponds to the two or more human interactions.

In some embodiments, the interacting may be associated with one or more of a step-by-step process of accessing the record.

In some embodiments, the set of human actions corresponds to the step-by-step process.

In some embodiments, the step-by-step process corresponds to one or more of an inputting the login credential, searching for the record, navigating through the software application, extracting a screenshot, extracting a field data, downloading the record document and closing the software application.

In some embodiments, the record data includes one or more of an image data, a field data and a document data.

In some embodiments, the image data may include an image of a content associated with a Graphical User Interface of the software application.

In some embodiments, the image data corresponds to a screenshot.

In some embodiments, the bot corresponds to a software robot.

In some embodiments, the method 300 may further include receiving, using the communication device 802, a layout indication data from the user device. Further, the layout indication data represents a user preference over the arrangement of two or more record data in the structured format. Further, the generating of the layout data may be further based on the layout indication data.

In some embodiments, the layout data further corresponds to a count of the two or more record data.

In some embodiments, the entity data may include a unique identifier of the record. Further, the record may be associated with the unique identifier in the software application.

In some embodiments, one or more of the set of human actions may be based on the unique identifier.

In some embodiments, the instruction data corresponds to a job which needs to be performed by the bot.

In some embodiments, the instruction data includes two or more instruction data corresponding to the record.

In some embodiments, the executing may be based on two or more bots.

In some embodiments, the method 300 may further include assigning, using the processing device 804, the two or more instruction data to the two or more bots. Further, the executing of the set of human actions may be based on the assigning.

In some embodiments, the two or more instruction data includes each of a first instruction data and a second instruction data. Further, the two or more bots includes each of a first bot and a second bot. Further, the first bot and the second bot may be assigned with the first instruction data and the second instruction data respectively.

In some embodiments, the two or more instruction data corresponds to two or more records. Further, the entity data corresponds to the two or more records.

In some embodiments, the extracting of the record data may be based on a machine learning algorithm.

In some embodiments, the executing responds data may be based on a manual review of the error.

In some embodiments, the presence of the anomaly corresponds to an error in the record data.

In some embodiments, the absence of the anomaly represents a completion of an extraction of the record data.

In some embodiments, the first document may be associated with a format. Further, the format includes a portable document format.

In some embodiments, the user device may be associated with the user. Further, the user may be associate with an organization. Further, the software application corresponds to a legacy application of the organization.

In some embodiments, the legacy application corresponds to an outdated software application of the organization.

In some embodiments, the record data includes one or more of a video data, an audio data and a text data.

In some embodiments, the user request data includes one or more of an image data, an audio data, a text data and a video data.

In some embodiments, the structured document data may be understandable by one or more AI models.

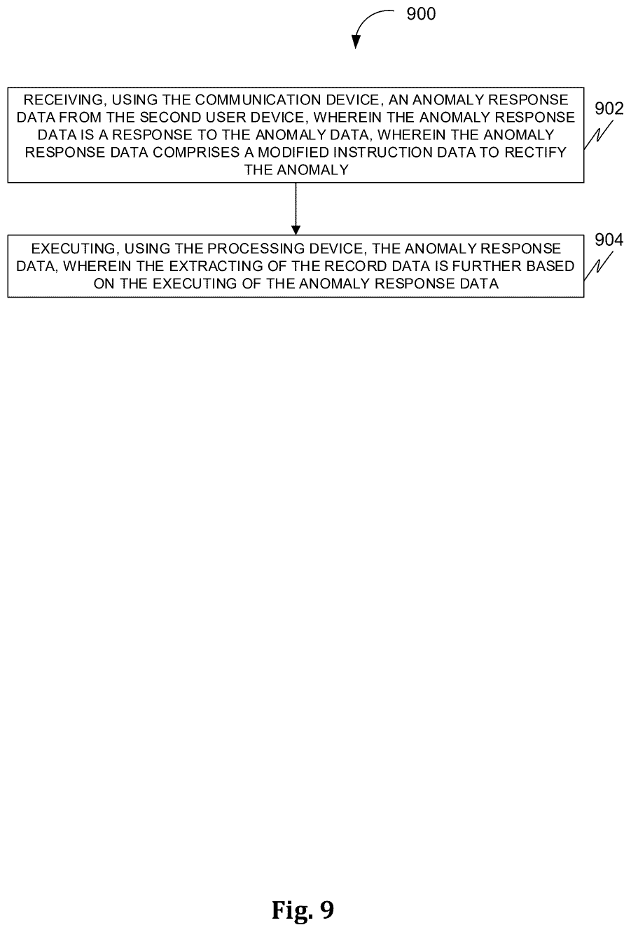

FIG. 9 illustrates a flowchart of a method 900 for facilitating decommissioning of a software application including executing, using the processing device 804, the anomaly response data, in accordance with some embodiments.

Further, in some embodiments, the method 900 further may include a step 902 of receiving, using the communication device 802, an anomaly response data from the second user device. Further, the anomaly response data may be a response to the anomaly data. Further, the anomaly response data includes a modified instruction data to rectify the anomaly. Further, in some embodiments, the method 900 further may include a step 904 of executing, using the processing device 804, the anomaly response data. Further, the extracting of the record data may be based on the executing of the anomaly response data.

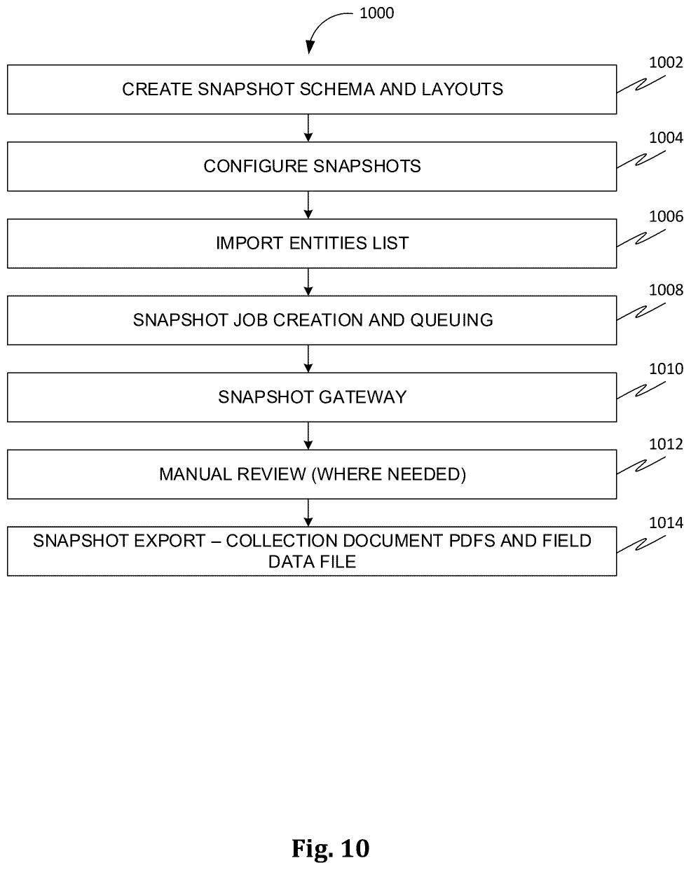

FIG. 10 is a flow chart of a method 1000 for facilitating providing information associated with a software application, in accordance with some embodiments. Accordingly, the method 1000 include a step 1002 of creating snapshot schema and layouts. Further, the method 1000 may include a step 1004 of configuring snapshots. Further, the method 1000 may include a step 1006 of importing entities list. Further, the method 1000 may include a step 1008 of snapshot job creation and queuing. Further, the method 1000 may include a step 1010 of calling snapbot via snapshot gateway. Further, the method 1000 may include a step 1012 of manual review of instructions. Further, the method 1000 may include a step 1014 of exporting snapshot. Further, the snapshot includes a collection of document PDF files and a field data file.

In further embodiments, a method for facilitating providing information associated with a software application, in accordance with some embodiments. Accordingly, the method may include obtaining, using a processing device, at least one information using at least one artificial intelligence model. Further, the at least one information may be associated with the software application (or application).

Further, the method may include generating, using the processing device, at least one schema and at least one layout associated with the at least one information. Further, the at least one schema may define a shape of the at least one information. Further, the at least one schema may be a field data. Further, the at least one layout may govern a format and number of snapshot documents.

Further, the method may include configuring, using the processing device, at least one snapbot.

Further, the method may include importing, using the processing device, at least one entity list based on the configuring of the at least one snapbot. Further, the at least one entity list may include an information indication associated with an information that at least one user may want to extract. Further, the at least one entity list may include unique identifiable information associated with at least one entity so a corresponding record in an application may be searched for and found

Further, the method may include generating, using the processing device, at least one snapbot job associated with at least one entity based on the at least one entity list.

Further, the method may include extracting, using the processing device, at least one field information associated with at least one field based on the at least one snapbot job.

Further, the method may include processing, using the processing device, the at least one field information.

Further, the method may include determining, using the processing device, at least one anomaly associated with the at least one field information.

Further, the method may include modifying, using the processing device, a review status corresponding to the at least one field information based on the determining.

Further, the method may include generating, using the processing device, at least one information document. Further, the at least one information document may include the at least one field for a given snapshot associated with the application. Further, in an instance, the at least one information document may include at least one PDF document. Further, the at least one information document may include a secondary file that may include an extracted field data associated with the at least one field.

Further, the method may include transmitting, using a communication device, the at least one information document to at least one user device associated with the at least one user. Further, the at least one user device may include a smartphone, a tablet, a laptop, and so on.

Further, the method may include storing, using a storage device, the at least one information document and the at least one information.

In further embodiments, a system for facilitating providing information associated with a software application, in accordance with some embodiments. Accordingly, the system may include a processing device configured for obtaining at least one information using at least one artificial intelligence model. Further, the at least one information may be associated with the software application (or application).

Further, the processing device may be configured for generating at least one schema and at least one layout associated with the at least one information. Further, the at least one schema may define a shape of the at least one information. Further, the at least one schema may be a field. Further, the at least one layout may govern a format and number of snapshot documents. Further, the processing device may be configured for configuring at least one snapbot. Further, the processing device may be configured for importing at least one entity list based on the configuring of the at least one snapbot. Further, the at least one entity list may include an information indication associated with an information that at least one user may want to extract. Further, the at least one entity list may include unique identifiable information associated with at least one entity so a corresponding record in an application may be searched for and found. Further, the processing device may be configured for generating at least one snapbot job associated with at least one entity based on the at least one entity list. Further, the processing device may be configured for extracting at least one field information associated with at least one field based on the at least one snapbot job. Further, the processing device may be configured for processing the at least one field information. Further, the processing device may be configured for determining at least one anomaly associated with the at least one field information. Further, the processing device may be configured for modifying a review status corresponding to the at least one field information based on the determining. Further, the review status may indicate if the at least one field information may need a manual review from the at least one user. Further, the processing device may be configured for generating at least one information document. Further, the at least one information document may include the at least one field for a given snapshot associated with the application. Further, the at least one information document may include a secondary file that may include an extracted field data associated with the at least one field.

Further, the system may include a communication device configured for transmitting the at least one information document to at least one user device associated with the at least one user. Further, the at least one user device may include a smartphone, a tablet, a laptop, and so on.

Further, the system may include a storage device configured for storing the at least one information document and the at least one information.

Although the invention has been explained in relation to its preferred embodiment, it is to be understood that many other possible modifications and variations can be made without departing from the spirit and scope of the invention as hereinafter claimed.

1. A method for facilitating decommissioning of a software application, the method comprising:
receiving, using a communication device, an entity data from a user device, wherein the entity data represents a record associated with the software application;
receiving, using the communication device, a login credential data from the user device, wherein the login credential data corresponds to a unique identifier of a user associated with the software application;
generating, using a processing device, an instruction data based on each of the entity data and the login credential data, wherein the instruction data represents a set of human-equivalent automated actions performed by a software bot, wherein the set of human-equivalent automated actions comprises at least one of an interacting with a Graphical User Interface of the software application, executing an Application Programming Interface calls to retrieve data and performing a direct database query;
executing, using the processing device, the instruction data, wherein the executing is based on a bot configured to mimic a structured user interaction with the software application;
extracting, using the processing device, a record data based on the executing; wherein the record data comprises at least one of a screenshot of a record display, a structured field data from a database of the software application and a documents attached to the record and an output from an executed report associated with or that which reference data contained within the record;
generating, using the processing device, a structured document data based on the extracting, wherein the structured document data corresponds to a document comprising the record data in a structured format; and
transmitting, using the communication device, the structured document data to the user device.

2. The method of claim 1 further comprises generating, using the processing device, a schema data based on the entity data, wherein the schema data corresponds to a plurality of sections associated with the record, wherein the generating of the instruction data is further based on the schema data.

3. The method of claim 1 further comprises generating, using the processing device, the layout data based on the entity data, wherein the layout data corresponds to an arrangement of a plurality of record data in the structured format, wherein the generating of the structured document data is further based on the layout data, wherein the record data comprises a plurality of record data.

4. The method of claim 1 further comprises:
generating, using the processing device, an execution error data based on the executing of the instruction data, wherein the execution error data represents an error in at least one of a software application login failure, an incorrect navigation within the software application and a missing or incomplete record data; and
transmitting, using the communication device, the execution error data to a second user device for manual review, wherein the second user device is associated with a second user.

5. The method of claim 4 further comprises:
receiving, using the communication device, an execution response data from the second user device, wherein the execution response data is a response to the execution error data, wherein the execution response data comprises a modified instruction data; and
executing, using the processing device, the execution response data, wherein the extracting of the record data is re-performed based on the modified instruction data.

6. The method of claim 1 further comprises:
analyzing, using the processing device, the record data;
generating, using the processing device, an anomaly identification data based on the analyzing of the record data, wherein the anomaly identification data represents at least one of a presence of an anomaly and an absence of the anomaly in the record data; and
transmitting, using the communication device, the anomaly identification data to a second user device, wherein the second user device is associated with a second user.

7. The method of claim 6 further comprises:
identifying, using the processing device, the anomaly data based on the analyzing of the record data, wherein the anomaly data corresponds to the anomaly in the record data, wherein the anomaly data further represents the instruction data associated with the anomaly; and
transmitting, using the communication device, the anomaly data to the second user device for a manual review of the instruction data.

8. The method of claim 1 further comprises storing, using a storage device, the structured document data in a database for a future reference, wherein the database comprises a plurality of structured document data stored at a plurality of time instances.

9. The method of claim 1, wherein the structured document data comprises a plurality of documents, wherein the plurality of documents comprises a first document and a second document, wherein the first document comprises at least one of a plurality of images and a downloaded document, wherein the second document comprises a plurality of field data associated with at least one of the plurality of images and the downloaded document.

10. The method of claim 1, wherein the extracting of the record data is further based on an AI model, wherein the AI model is trained on at least one of a metadata from previously extracted record, an application-specific navigation pattern, a prior error log and manual correction and a predictive data structure inferred from previous extraction.

11. A system for facilitating decommissioning of a software application, the system comprising:
a communication device configured for:
receiving an entity data from a user device, wherein the entity data represents a record associated with the software application;
receiving a login credential data from the user device, wherein the login credential data corresponds to a unique identifier of a user associated with the software application;
transmitting a structured document data to the user device;
a processing device configured for:
generating an instruction data based on each of the entity data and the login credential data, wherein the instruction data represents a set of human-equivalent automated actions performed by a software bot, wherein the set of human-equivalent automated actions comprises at least one of an interacting with a Graphical User Interface of the software application, executing an Application Programming Interface calls to retrieve data and performing a direct database query;
executing the instruction data, wherein the executing is based on a bot configured to mimic a structured user interaction with the software application;
extracting a record data based on the executing; wherein the record data comprises at least one of a screenshot of a record display, a structured field data from a database of the software application and a documents attached to the record and an output from an executed report associated with or that which reference data contained within the record; and
generating the structured document data based on the extracting, wherein the structured document data corresponds to a document comprising the record data in a structured format.

12. The system of claim 11, wherein the processing device is further configured for generating a schema data based on the entity data, wherein the schema data corresponds to a plurality of sections associated with the record, wherein the generating of the instruction data is further based on the schema data.

13. The system of claim 11, wherein the processing device is further configured for generating the layout data based on the entity data, wherein the layout data corresponds to an arrangement of a plurality of record data in the structured format, wherein the generating of the structured document data is further based on the layout data, wherein the record data comprises a plurality of record data.

14. The system of claim 11, wherein the processing device is further configured for generating an execution error data based on the executing of the instruction data, wherein the execution error data represents an error in at least one of a software application login failure, an incorrect navigation within the software application and a missing or incomplete record data, wherein the communication device is further configured for transmitting the execution error data to a second user device for manual review, wherein the second user device is associated with a second user.

15. The system of claim 14, wherein the communication device is further configured for receiving an execution response data from the second user device, wherein the execution response data is a response to the execution error data, wherein the execution response data comprises a modified instruction data, wherein the processing device is further configured for executing the execution response data, wherein the extracting of the record data is re-performed based on the modified instruction data.

16. The system of claim 11, wherein the processing device is further configured for:
analyzing the record data; and
generating an anomaly identification data based on the analyzing of the record data, wherein the anomaly identification data represents at least one of a presence of an anomaly and an absence of the anomaly in the record data, wherein the communication device is further configured for transmitting the anomaly identification data to a second user device, wherein the second user device is associated with a second user.

17. The system of claim 16, wherein the processing device is further configured for identifying the anomaly data based on the analyzing of the record data, wherein the anomaly data corresponds to the anomaly in the record data, wherein the anomaly data further represents the instruction data associated with the anomaly, wherein the communication device is further configured for transmitting the anomaly data to the second user device for a manual review of the instruction data.

18. The system of claim 11 further comprises a storage device configured for storing the structured document data in a database for a future reference, wherein the database comprises a plurality of structured document data stored at a plurality of time instances.

19. The system of claim 11, wherein the structured document data comprises a plurality of documents, wherein the plurality of documents comprises a first document and a second document, wherein the first document comprises at least one of a plurality of images and a downloaded document, wherein the second document comprises a plurality of field data associated with at least one of the plurality of images and the downloaded document.

20. The system of claim 11, wherein the extracting of the record data is further based on an AI model, wherein the AI model is trained on at least one of a metadata from previously extracted record, an application-specific navigation pattern, a prior error log and manual correction and a predictive data structure inferred from previous extraction.
